(19) United States
(12) Patent Application Publication
(10) Pub. No.: US 2011/0209067 A1
(43) Pub. Date: Aug. 25, 2011

(54) System and Method for Website User Valuation

(76) Inventors: KeAndre Bogess, Grand Prairie, TX (US); Michelle Strong, Dallas, TX (US); Brian Fugere, Flower Mound, TX (US); Lauren Lamb, Plano, TX (US)

(21) Appl. No.: 12/709,250

(22) Filed: Feb. 19, 2010

(51) Int. Cl. G06F 15/177

(52) U.S. Cl. 715/736

(57) ABSTRACT

Systems and methods for website user valuation are disclosed. A preferred embodiment comprises a computer program product having a computer-readable medium with a computer program embodied thereon. The computer program comprises computer program code for inputting revenue data for a period of time for a monitored website, for inputting website user engagement data for the period of time for multiple user segments, for determining a segment revenue for the period of time for each of the multiple user segments, based on the user engagement data, and for determining a value per user for the period of time for each of the multiple user segments, based on the user engagement data.

### TECHNICAL FIELD

The present invention relates generally to a system and method for website user valuation, and more particularly to a system and method for website user valuation based on user activity.

### BACKGROUND

Computer networks have become ubiquitous around the world, with the Internet interconnecting many of these computer networks to each other. Generally, the Internet is a global system of interconnected computer networks and serves billions of users worldwide. The Internet is a network of networks that consists of millions of private, public, academic, business, and government networks of local to global scope that are linked by a broad array of wired and wireless, electronic and optical networking technologies. The Internet carries a vast array of information resources and services such as the inter-linked hypertext documents of the World Wide Web and the infrastructure to support electronic mail. The World Wide Web generally is a global set of documents, images and other resources, logically interrelated by hyperlinks and referenced with Uniform Resource Identifiers (“URI”s). URIs allow providers to symbolically identify services and clients to locate and address web servers, file servers, and other databases that store documents and provide resources and access them using the Hypertext Transfer Protocol (“HTTP”).

Many traditional communications media, such as telephone and television services, have been modified using the technologies of the Internet, giving rise to services such as Voice over Internet Protocol and Internet Protocol Television. Newspaper publishing has been modified to include, for example, websites, blogging, and web feeds. The Internet also has enabled or accelerated the creation of new forms of human interactions through instant messaging, Internet forums, and social networking sites.

One such interactive phenomenon is social media. Social media generally refers to the various activities that integrate technology, social interaction, and the creation and use of works such as text, images, audio, video, and multimedia. Social media generally has changed how people engage, participate, and share online. In some contexts, social media may be referred to as user generated content (“UGC”) or consumer generated media (“CGM”), while in other contexts UGC and CGM may refer to the data generated by the users of websites having social media.

Social media provides for many different types of communication (e.g., blogs, micro-blogs, social networks), collaboration (e.g., wikis, bookmarking, social news), multimedia (e.g., photos, video, live casting) and reviews and opinions (e.g., product, business, community). Other examples of social media include commenting functionality, user profiles, image, audio, video and multimedia uploading, recommendations, and friending capabilities.

### SUMMARY OF THE INVENTION

As discussed in detail below, problems and shortcomings of the prior art are generally solved or circumvented, and technical advantages are generally achieved, by preferred embodiments of the present invention, which provide systems and methods for web user valuation.

In accordance with a preferred embodiment of the present invention, a method for website user valuation comprises inputting revenue data for a period of time for a monitored website, inputting website user engagement data for the period of time for multiple user segments, determining, using a microprocessor, a segment revenue for the period of time for each of the multiple user segments, based on the user engagement data, and determining, using a microprocessor, a value per user for the period of time for each of the multiple user segments, based on the user engagement data.

In accordance with another preferred embodiment of the present invention, a computer system comprises a memory storing a computer program and a data processor for executing the computer program stored in the memory. The computer program stored in the memory comprises computer code for website user valuation, the computer code including instructions for inputting revenue data for a period of time for a monitored website, instructions for inputting website user engagement data for the period of time for multiple user segments, instructions for determining a segment revenue for the period of time for each of the multiple user segments, based on the user engagement data, and instructions for determining a value per user for the period of time for each of the multiple user segments, based on the user engagement data.

In accordance with another preferred embodiment of the present invention, a computer program product for performing website user valuation has a computer-readable medium with a computer program embodied thereon, and the computer program comprises computer program code for inputting revenue data for a period of time for a monitored website, computer program code for inputting website user engagement data for the period of time for multiple user segments, computer program code for determining a segment revenue for the period of time for each of the multiple user segments, based on the user engagement data, and computer program code for determining a value per user for the period of time for each of the multiple user segments, based on the user engagement data.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 is a chart comparing various user segments and their valuations;

FIG. 2 is a high level block diagram of a computer network;

FIG. 3 is a high level block diagram of a computer system;

FIG. 4 is a flow chart of a method for website user valuation;

FIG. 5 is a flow chart of a method for website user valuation;

FIG. 6 is a flow chart of a method for website user valuation;

FIG. 7a is a table illustrating data acquisition for website user valuation;

FIG. 7b is a table illustrating revenue determination for various types of website users; and

FIG. 7c is a table illustrating valuations for various types of website users and user segments.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely website user valuation for news and television media-provider websites. The invention also may be applied, however, to websites for other types of content providers, such as other types of publishers, personal, government, academic and commercial websites, social networking websites, collaborative websites, research websites, etc. The media provided on the websites may be any combination of text, images, audio, video, interactive media, and other forms of computer-transmitted data.

As previously discussed, social media has provided additional dimensions to the utility of and uses for websites by facilitating, for example, many different types of user communication, collaboration, multimedia, reviews, opinions and feedback. The advent of social media has accentuated the rise of different types of users on the web. From the traditional types such as content providers and content users, there are now different types of content contributors. These different user segments generally have different levels of engagement with websites, as well as have different levels of value to those websites. For example, as overall segments, highly engaged users generally are more valuable than periodic content users. Generally, the more a visitor engages with a website, the more valuable the visitor becomes to the website provider.

For example, in the news context, interaction with the newsroom, enhancing research communities, and increasing a users' experience may drive higher engagement and result in lower cost new gathering, advertiser retention, and a higher value per user. With respect to the newsroom, methods of driving higher engagement may include providing online news packages, engaging the provider in its own content, and providing content that reaches out to the provider's base. With respect to enhancing research communities, methods of driving higher engagement may include providing niche audience research, providing content research and leads for advertisers, providing new product and services research and testing, and providing marketing, promotions, and communications feedback. With respect to increasing users' experience, methods of driving higher engagement may include providing specialized user niches, providing local user communities, providing consistent user experiences, providing social bridging capabilities, and providing user application development capability.

Increased interaction with and between users generally drives higher engagement of the users with the website. That is, connecting users with the provider, the provider's clients, their community and each other may increase user participation, user registration, and other key user metrics. Higher user engagement in turn may drive lower cost news gathering by providing, for example, more frequent feedback, more investment in local coverage, reverse publishing user contributions, and guest news coverage. Higher user engagement also may enhance advertiser retention by providing, for example, unique vertical insight for sales tools, improved advertising return on investment via evaluations, improved business to consumer research, and improved targeting for the provider's clients. Higher user engagement also may drive a higher value per user by providing lower user churn, providing a core, quality audience, and providing more effective marketing at a lower cost.

Higher user engagement, therefore, may significantly increase the value of a provider's website, and the revenue generated by that website. Previously, however, it was difficult to determine which types of users were more valuable to the website provider. While prior art online revenue models that monitor, for example, ad impressions, ad clicks, goods purchases may be useful for determining revenue and cost structures, they do not provide sufficient information as to the relative value of different types of users. Without knowing which types of users were more valuable, it was difficult to determine how to increase the value of the users. Businesses generally operated and made decisions based on the above revenue models and assumptions of users' engagement levels and users' corresponding value on the web site.

Generally, an embodiment of the present of invention categorizes website visitors into different user segments, monitors the various user actions taken when interacting with the website, and then equates those actions to revenue for the website. That is, an embodiment of the present invention attributes revenue to users based on their engagement actions throughout a website. Generally, this allows for a value comparison of different user segments and provides insight into the relative value of the user segments. Furthermore, the website provider may identify the user actions that contribute the most revenue. The website provider also may focus local site efforts on driving the most profitable actions.

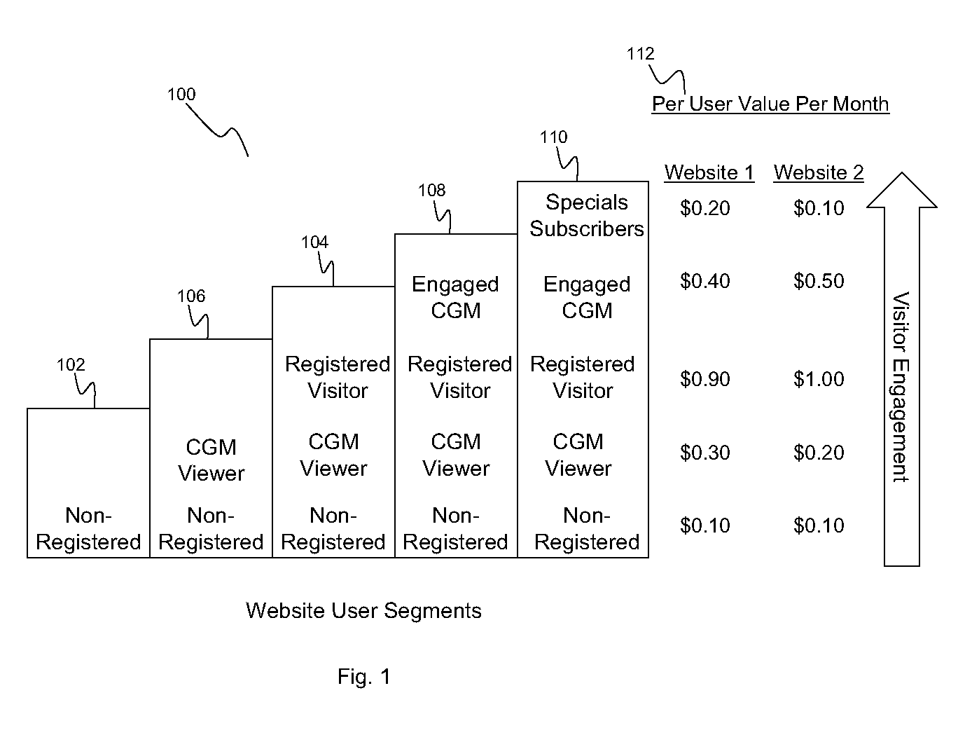

FIG. 1 is a chart 100 comparing various user segments and their valuations. As shown in FIG. 1, user segments may be classified in many different ways. For example, user segments may include local users, non-local users, registered users, non-registered users, CGM viewers, engaged CGM participants, and specials subscribers.

Non-registered user segment 102 represents website visitors who have not encountered or completed the registration process to become registered users. Registered user segment 104 represents website visitors who completed the registration process to become registered for the website. CGM viewer segment 106 represents website visitors who view pages with CGM content but do not engage by submitting their own content, such as comments, images or video. Engaged CGM participant segment 108 represents website visitors who upload content, such as a comment, recommendation, image or video, to the website during their visits. Specials subscriber segment 110 represents registered visitors who voluntarily subscribed to receive email specials.

User segments may be exclusive or nonexclusive. For example, non-registered and registered user segments are exclusive of each other, and together represent all visitors to a website. User segments may overlap with other segments or may be fully inclusive of other segments. For example, if an engaged CGM participant is required to register on a website before posting data, then all engaged CGM participants are registered users, but not necessarily vice versa.

User segments may include other many segments not shown in FIG. 1. For example, users of a website that is focused on a primary geographic region or area, such as a local news provider, may be divided into local users and non-local users. Local users may be located in or near the geographic area, while non-local users are located outside of the region. As an example, the region may be a zip code, a city, a designated market area (“DMA”), a state, and the like. Other geographic variables may be used to divide a user population into different segments, such as population density, population growth rate, climate, and the like.

Other parameters that may be used to segment a user population include demographic parameters, psychographic parameters, behavioral parameters, etc. Demographic parameters may include variables such as age, gender, ethnicity, education, occupation, income, family status, and the like. Psychographic parameters may include variables such as values, attitudes, lifestyle, and the like. Behavioral parameters may include variables such as usage rate, usage patterns, price sensitivity, brand loyalty, benefits sought, time on site, and the like. Users also may segmented by content affinity, for example by those with affinities for content such as weather, sports, business, lifestyle, politics, national, international, opinion, and the like.

Any defined segment monitored by a website analytic tool may be used as a user segment. For example, a web site provider may desire to track a video user segment or a mobile user segment. Once the web analytic tool has identified a visitor segment, the metrics for that segment, such as page view consumption, may be tracked, analyzed, and attributed revenue.

Once identified, user segments may be monitored and measured by a web analytic tool in various ways. For example, as will be described in more detail herein below, user engagement metrics used for analyzing user segments may include page views, unique visitors, new registrations, email subscriber opt-in, etc. Based on the engagement information, and based on revenue information for the website, the user valuation tool may determine and attribute revenue over a certain period of time to each user segment. The user valuation tool then may determine the per user value per the period of time. In FIG. 1, the selected time period is one month and per user value per month 112 is shown for two different websites, website 1 and website 2. In this example, as can be seen by the amounts shown for the different types of user segments, users who participate less, such as non-registered users 102 and CGM viewers 106, generally provide less revenue than more active participants, such as registered users 104 and engaged CGM participants 108.

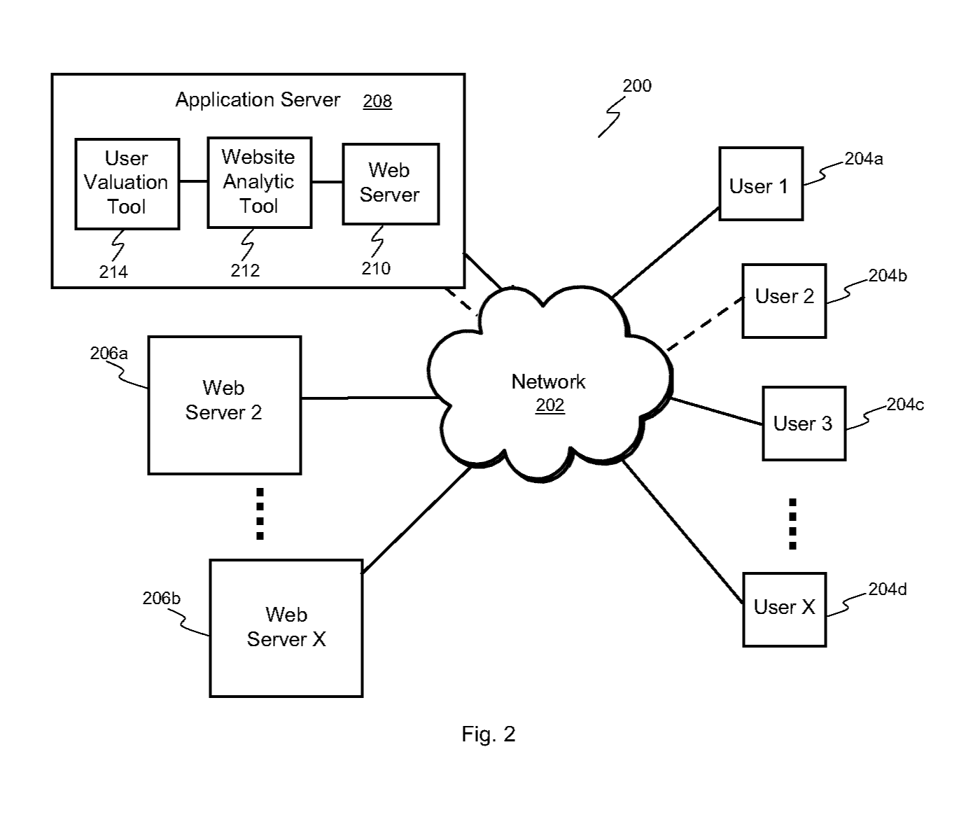

FIG. 2 is a high level network block diagram 200 of a computer system network that may embody or utilize features of an embodiment of the present invention. One of ordinary skill in the art will realize that the network diagram 200 has been simplified to better illustrate features of embodiments of the present invention. Some well-known elements are not shown, but nonetheless are part of a network embodying or utilizing features of the present invention. For example, a network or system embodying or utilizing the present invention may include gateways, routers, firewalls, file servers, databases, maintenance systems, and the like.

The network block diagram 200 comprises network 202 that interconnects users 204 to web servers 206 and 210. Network 202 may comprise the Internet, and may comprise various public or private networks connecting computer systems to each other. The interconnection of user devices and content servers to the Internet and each other is well known to those of ordinary skill in the art. Each of the users 204 may comprise a general purpose computing device, such as a personal computer, a mini-computer, a mainframe, a personal data assistant, a laptop, tablet or other mobile computer, a smart phone, or the like, configured to communicate over network 202 with web servers 206 and 210. Users 204 may be connected to network 202 via any type of wireline (user 204a) (optical, phone line, cable, local area network, etc.) or wireless (user 204b) (WiFi, 3G, 4G, WiMAX, etc.) communications link, or both.

Each of the web servers 206 may comprise a general purpose computing device, such as those listed above, configured to communicate with other devices connected to network 202. As with users 204, web servers 206 may be connected to network 202 via any type of wireline or wireless communications link, or both.

Application server 208 comprises web server 210, website analytic tool 212, and user valuation tool 214. Application server 208 may comprise a general purpose computing device, such as those listed above, configured to communicate with other devices connected to network 202. As with the other devices shown, application server 208 may be connected to network 202 via any type of wireline or wireless communications link, or both. As indicated in FIG. 2, web server 210, website analytic tool 212, and user valuation tool 214 are located in the same device 208.

In other embodiments, each of these components may be located in any combination of different general purpose computing devices, located at the same or a plurality of physical locations. For example, two of the three components may be implemented one general purpose computing device, while the third component may be implemented on a different general purpose computing device. The different components may be directly connected to each other or via a network such as network 202. Furthermore, the functions performed by each of the components may be performed by the owner of website or by third parties. For example, the web server and website hosting services may be provided by website hosting company. As another example, the generation of raw data regarding revenue generated by the website or the monitoring of user engagement with the website may be performed by a third party.

All components or functions described herein may be performed in either hardware or software, or some combination thereof, unless indicated otherwise. In one preferred embodiment, the functions are performed by a processor such as a computer or an electronic data processor or in accordance with code such as computer program code, instructions, software, and/or integrated circuits that are coded to perform such functions, unless indicated otherwise.

Web server 210 is connected to network 202 for providing requested web pages and other data to users 204. Using World Wide Web browser software, such as Internet Explorer, Firefox, Safari, or Chrome, users 204 may navigate from one web page to another via hyperlinks embedded in the documents. Web server 210 may provide primarily a single website, part of a website, or multiple websites to users.

Website analytic tool 212 monitors user activity in accessing web server 210, and measures user engagement metrics, such as page views, for different user segments for a given website or websites. Website analytic tool 221 may additionally or alternatively monitor user access of web servers other than web server 210, such as web servers 206.

User valuation tool 214 may use the engagement information for the various user segments collected by website analytic tool 212, along with revenue information for the selected website or websites to determine and attribute revenue over a certain period of time to each user segment. The user valuation tool 214 also may determine the per user value per the period of time.

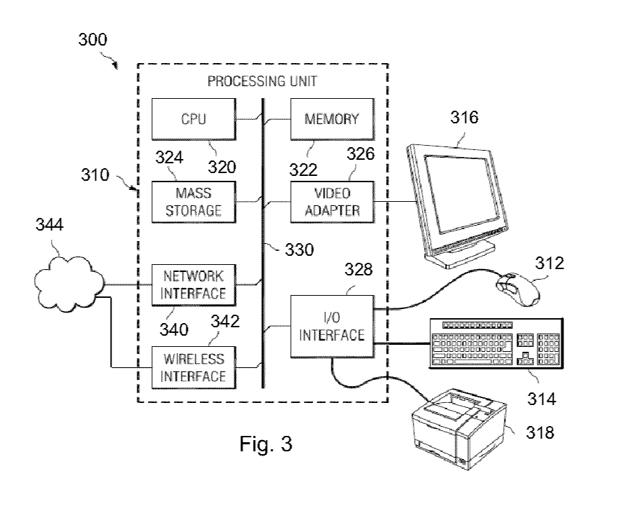

FIG. 3 is a high level block diagram of a computer system 300 that may be used in accordance with an embodiment of the present invention. For example, application server 208 may be implemented on one or more such computer systems 300. Computer system 300 may comprise a processing unit 310, such as a desktop computer, a workstation, a laptop computer, a personal digital assistant, a dedicated unit customized for a particular application, or the like, equipped with one or more input devices, such as a mouse 312, a keyboard, 314, and the like, and one or more output devices, such as a display 316, a printer 318, and the like. The processing unit 310 may include a central processing unit (CPU) 320, memory 322, a mass storage device 324, a video adapter 326, and an I/O interface 328 connected to a bus 330.

The bus 330 may be one or more of any type of several bus architectures including a memory bus or memory controller, a peripheral bus, video bus, and the like. The CPU 320 may comprise any type of electronic data processor or multiples thereof. For example, the CPU 320 may comprise a Core processor from Intel Corp., a Phenom processor from Advanced Micro Devices, Inc., a Reduced Instruction Set Computer (“RISC”), or the like. The memory 322 may comprise any type of system memory such as static random access memory (“SRAM”), dynamic random access memory (“DRAM”), synchronous DRAM (“SDRAM”), read-only memory (“ROM”), a combination thereof, and the like. In an embodiment, the memory 322 may include ROM for use at boot-up, and DRAM for data storage for use while executing programs.

The mass storage device 324 may comprise any type of storage device configured to store data, programs, and other information and to make the data, programs, and other information accessible via the bus 330. The mass storage device 324 may comprise, for example, one or more of a hard disk drive, a solid-state drive, a magnetic disk drive, an optical disk drive, and the like.

The video adapter 326 and the I/O interface 328 provide interfaces to couple external input and output devices to the processing unit 310. As illustrated in FIG. 3, examples of input and output devices include the display 316 coupled to the video adapter 326, and the mouse 312, keyboard 314, and printer 318 coupled to the I/O interface 328. Other devices may be coupled to the processing unit 310, and additional or fewer interface cards may be utilized. For example, a serial interface card (not shown) may be used to provide a serial interface for a printer.

The processing unit 310 also preferably includes a network interface 340 and a wireless interface 342. The network interface 340 and the wireless interface 342 allow the processing unit 310 to communicate with other devices via network 344. In an embodiment, the processing unit 310 is coupled to a local-area network or a wide-area network to provide communications with other devices and networks, such as other processing units, the Internet, user devices, and the like. The network interface 340 may provide an interface for a wired link, such as an Ethernet cable, or the like. The wireless interface 342 may be configured to communicate via a wireless local area network protocol such as 801.11b, 801.11g, or the like.

The computer system 300 may include other components. For example, the computer system 300 may include power supplies, cables, a motherboard, removable storage media, cases, and the like. These other components, although not shown, may be considered part of computer system 300.

Embodiments of the invention may be implemented on computer system 300. For example, an embodiment may be implemented in computer program code that is stored semi-permanently on in mass storage 324, stored temporarily in memory 322, and executed by CPU 320 while utilizing memory 322 and optionally mass storage 324. In addition, an embodiment of the invention may be implemented as a computer program product stored computer-readable media, such as electronic, magnetic or optical media. These may include removable and external types of media, including optical media such as CDs or DVDs, magnetic media such as portable hard drives and computer tape, electronic or solid-state media such as flash drives, and the like.

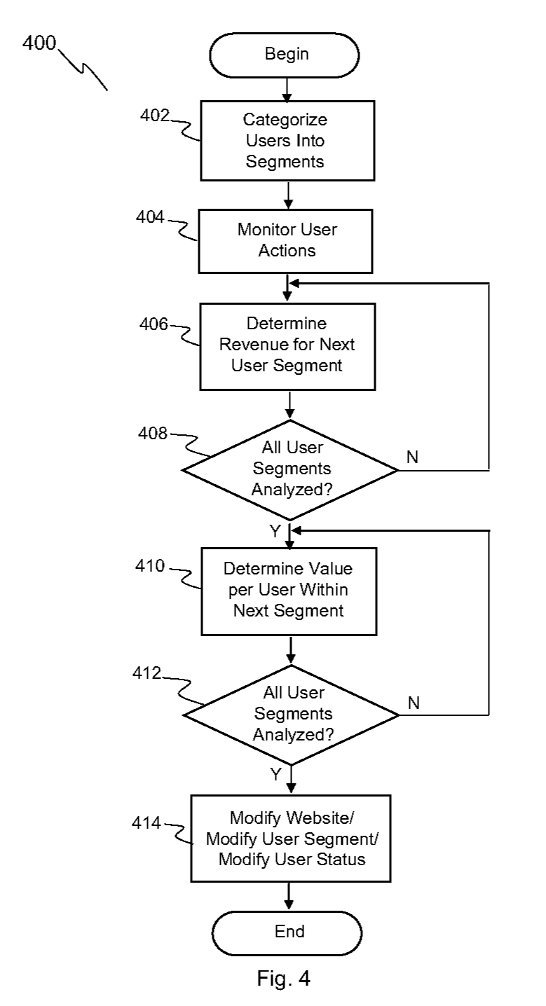

FIGS. 4, 5 and 6 are flow charts of various methods for website user valuation. In these flow charts, the different steps may be formed on a single computer system or on multiple computer systems. The steps may be performed sequentially, simultaneously, or in different order than those shown unless otherwise indicted (e.g., a subsequent step requires data generated by previous step). Some steps may be performed automatically or manually. Also, the transfer of the results from one step to another may be performed automatically or manually. In variations on the methods, not all steps are performed, or additional steps are performed.

FIG. 4 is a flow chart of an embodiment for website user valuation. The method generally attributes revenue to users based on their engagement levels within a website. That is, the method generally attributes monetary value to users based on the users' actions while visiting the website. In step 402, users are categorized into different user segments based on user characteristics that are of interest to the website provider. For example, the users may be grouped as registered or non-registered users, local or non-local users, CGM viewers, engaged CGM participants, and specials subscribers. There are many other user segments possible, depending on the needs and goals of the website provider. For example, users may be grouped as referred users (e.g., directed from sites such as Google, Yahoo!, Bing, and the like) or non-referred users, classified page users or non-classified page users, and the like.

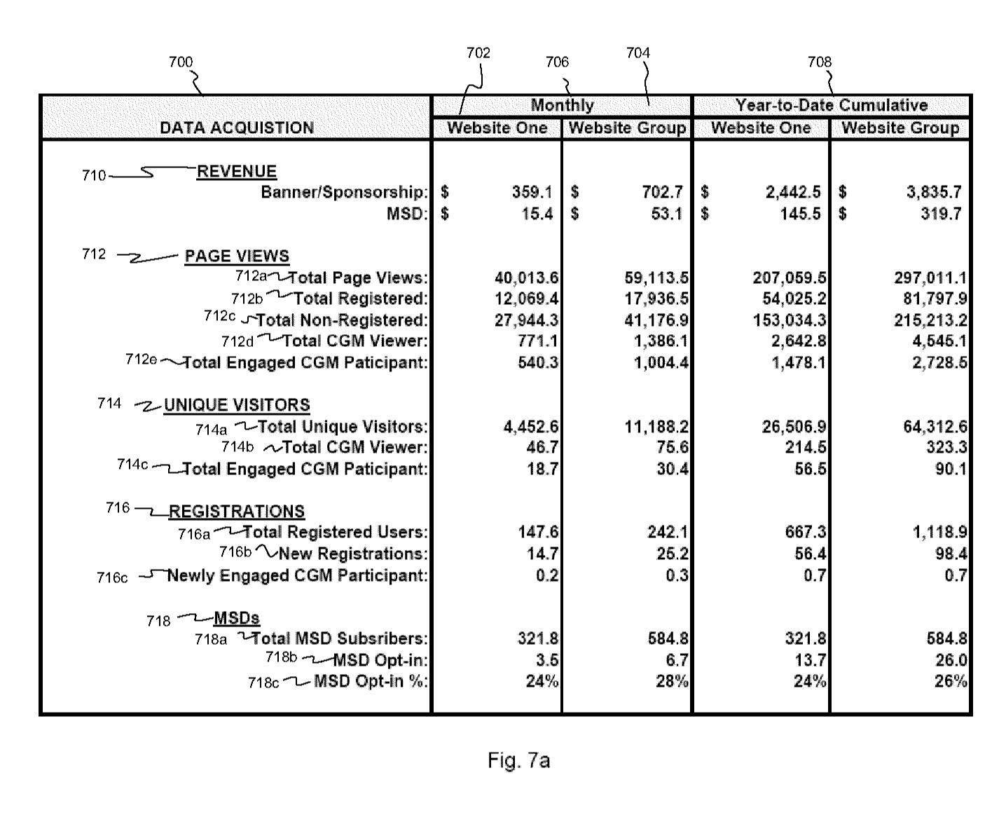

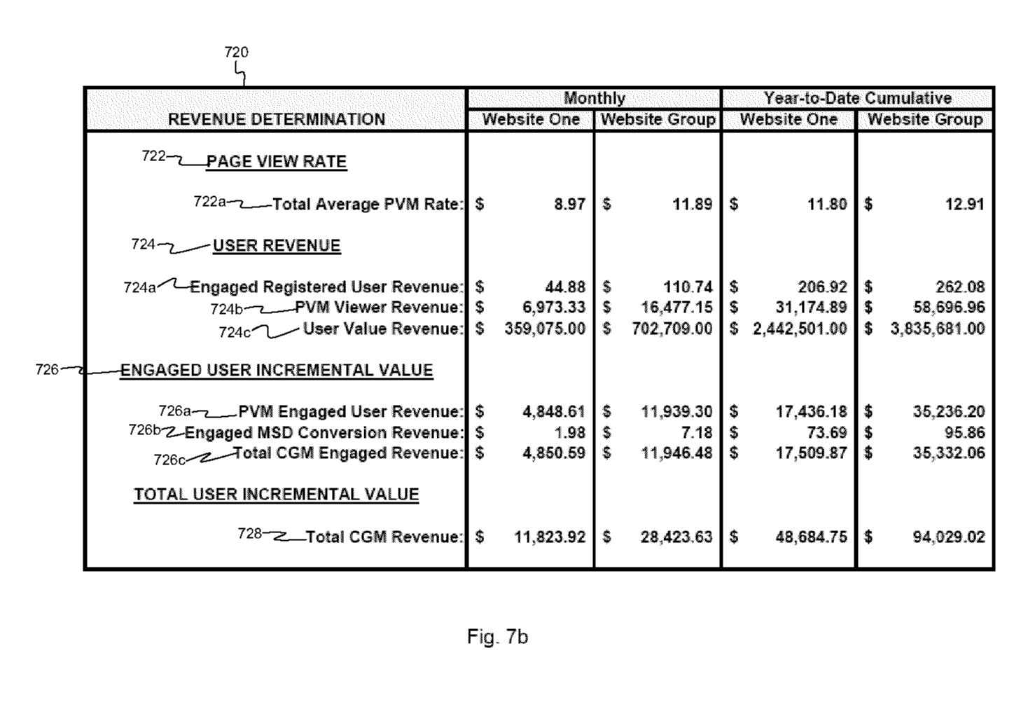

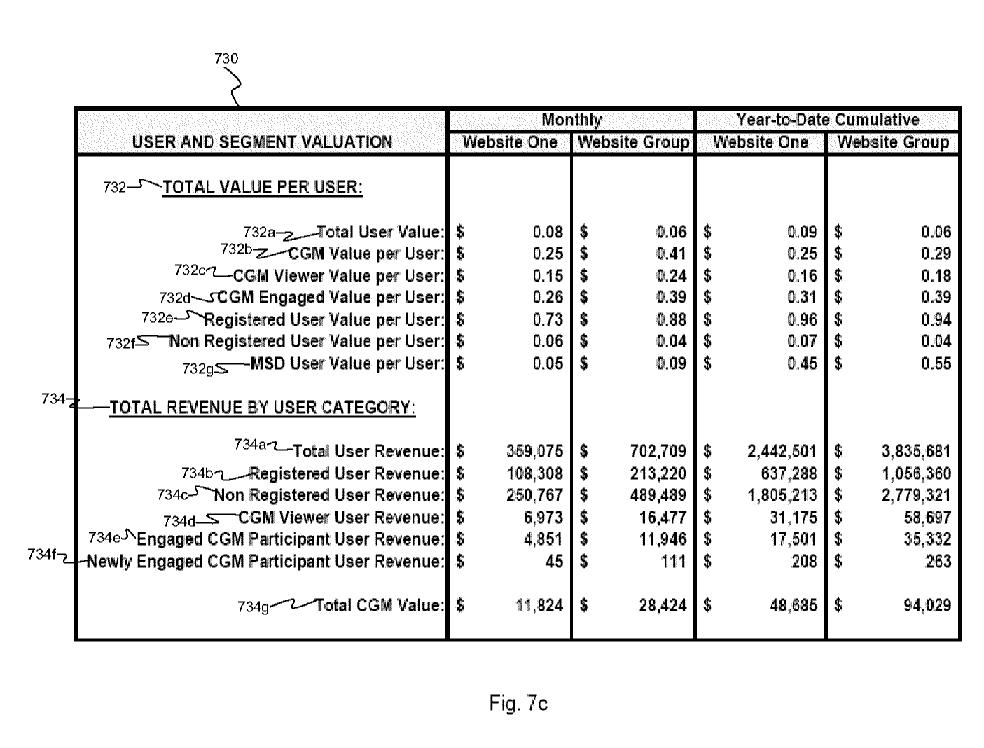

As users access the website and the website server provides web pages to the users, the website analytic tool may monitor record the users' engagement actions in step 404. In this example, the monitored actions are page views, although other metrics may be monitored, such as unique visitors, new registrations, email subscriber opt-in, and the like. The website analytic tool stores the number of page views for each type of user segment being monitored. The monitoring may be performed for a certain period of time, such as a day, week, month, year-to-date, or year, or any combination or multiple thereof. Likewise, the data may be stored for each user segment for similar time periods. Alternatively, the website analytic tool may store raw data to be grouped into selected time periods and selected user segments in subsequent analysis. Examples of these measurements are provided in FIG. 7a, described in detail below.

Once sufficient data about user engagement activity has been collected for analysis, the website user valuation tool may determine revenue for each user segment in step 406. The user valuation tool takes as inputs the user engagement data and overall revenue data for the website over the same time periods. The revenue data may be based on banner and sponsorship revenue for the website. Other forms of revenue may be included as discussed herein below. To determine user revenue for each user segment, the user valuation tool first determines an average page view per thousand rate (“PVM”), which is website revenue times user page views divided by 1000, for each of the selected time periods. Using this rate, the user valuation tool may analyze each user segment in steps 406 and 408 to determine revenue per user segment. Examples of these calculations are described in detail below with reference to FIGS. 7b and 7c.

The website user valuation tool also may determine the value per user for each user segment in step 410. These values are determined as shown in FIG. 7c and accompanying text. A value per user is calculated for each user segment in steps 410 and 412, and these numbers provide a ready comparison of the relative values of each user segment to the website provider. The website provider may utilize these numbers in determining strategy and tactics for further improving the website, attracting new users, increasing the value of existing users, and the like.

In step 414, the website provider may modify the website to better cater to the more valuable user segments. For example, the website provider may find that engaged CGM participants provide greater value to the website, and therefore provide more web pages with the ability to accept CGM, or the like. Additionally or alternatively, the website provider may modify a user segment to change the interaction of that segment with the website. For example, the website provider may offer engaged CGM participants the ability to submit additional content not previously offered, such enhanced multimedia, blogging, or the like. Additionally or alternatively, the website provider may modify the status of select users to make them more valuable. For example, the website provider may sign up a selected group of users to receive trial specials subscriptions, or may offer free or discounted registration to a select group of users, or the like, thus converting the users to more valuable user segments.

As an example, the website user valuation tool may indicate that registered users are much more valuable than non-registered users, so the website provider may focus on actions to convert non-registered users to registered users. One method of accomplishing this is to lower the barriers to registration, such as by accepting a multi-use user ID and password. Or the website user may implement a decentralized user authentication method, such as OpenID. The users may then log into the website with an existing ID from another entity, such as Google, Facebook, AOL, Yahoo!, or LiveJournal, among many others. This implementation thus removes the need for users to create another user name and password specifically for the target site. By having the opportunity to log in with a previously-created profile, users generally will be more likely to become registered members of the target site, thus becoming more valuable to the website owner.

As another example, the website user valuation tool may determine that CGM participants are more valuable than others, and thus the website user would want to make the CGM participant experience as smooth and seamless as possible. If, for example, the commenting process on blogs is different than the commenting process on articles, the variations in the two platforms can cause user confusion and deter participation. After realizing the increased value of CGM participants, the website owner may transition the system and process for blog commenting to the same system and process as that for article commenting, or vice versa.

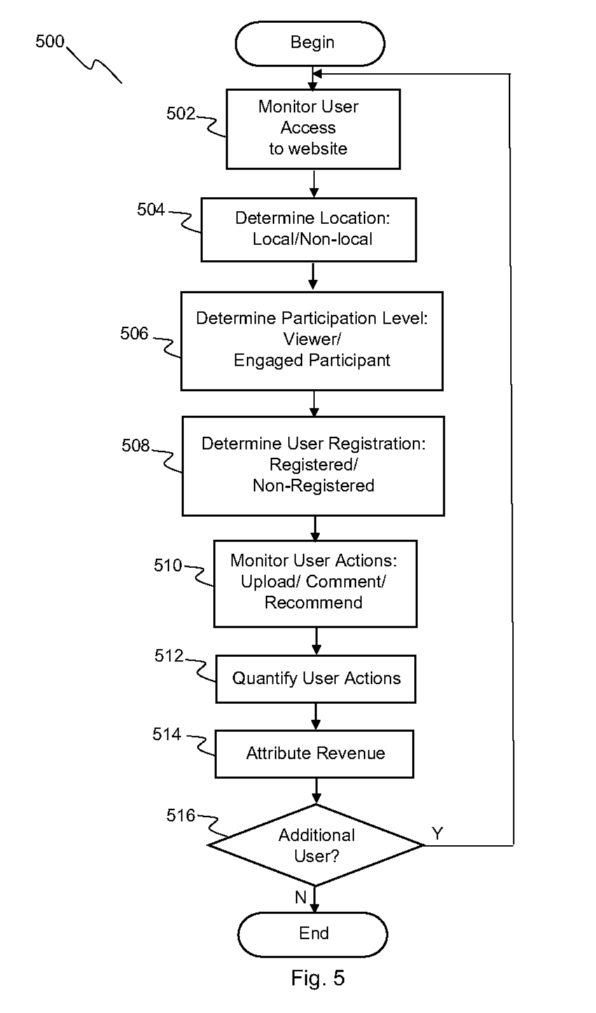

FIG. 5 is a flow chart 500 of an embodiment method for website user valuation. This method also generally attributes revenue to users based on their engagement levels within a website. As users interact with a website provided by a web server, a website analytic tool may monitor user access to the website in step 502. The website analytic tool then determines what type of user segment the user fits into in steps 504-508. In step 504, the location of the user is determined. If the user is within a designated market area, then the user is classified as a local user. If not, then the user is classified as a non-local user.

In step 506, the website analytic tool determines the CGM participation level of the user. If the user is viewing CGM but not contributing CGM, then the user is classified as a CGM viewer. If the user is contributing CGM, then the user is classified as an engaged CGM participant. In step 508, the website analytic tool determines whether the user is registered with the website. If so, the user is classified as a registered user, and if not, the user is classified as a non-registered user.

In step 510, the website analytic tool monitors the actions of users as they interact with the website. In this example, the monitored actions are page views, although other metrics may be monitored, such as unique visitors, new registrations, email subscriber opt-in, and the like. As another example, the website analytic tool may monitor for the type of participation engaged in by a CGM participant. As shown in step 510, a CGM participant may take a number of different actions, such as uploading images or video, or commenting on an article, or recommending an article, service or product to others.

The website analytic tool stores the engagement activity for each user segment in step 512. The monitoring may be performed for a certain period of time, such as a day, week, month, year-to-date, or year, or any combination or multiple thereof. Likewise, the data may be stored for similar time periods. Alternatively, the website analytic tool may store raw data to be grouped into selected time periods and selected user segments in subsequent analysis. Examples of these measurements are provided in FIG. 7a, described in detail below.

In step 514, the website user valuation tool may attribute revenue for each user segment. The user valuation tool takes as inputs the user engagement data and overall revenue data for the website over the same time periods. The revenue data may be based on banner and sponsorship revenue for the website. Other forms of revenue may be included as discussed herein below. To determine user revenue for each user segment, the user valuation tool first determines an average page view per thousand rate (“PVM”), which is website revenue times user page views divided by 1000, for each of the selected time periods. Using this rate, the user valuation tool may analyze each user segment in steps 406 and 408 to determine revenue per user segment. Examples of these calculations are described in detail below with reference to FIGS. 7b and 7c.

In attributing revenue, the website user valuation tool also may determine the value per user for each user segment. These values are determined as shown in FIG. 7c and accompanying text. The value per user for each user segment provides a ready comparison of the relative values of each user segment to the website provider. The website provider may utilize these numbers in determining strategy and tactics for further improving the website, attracting new users, increasing the value of existing users, and the like, as discussed in the previous embodiment. The process may continue at step 516 as users continue to access the website.

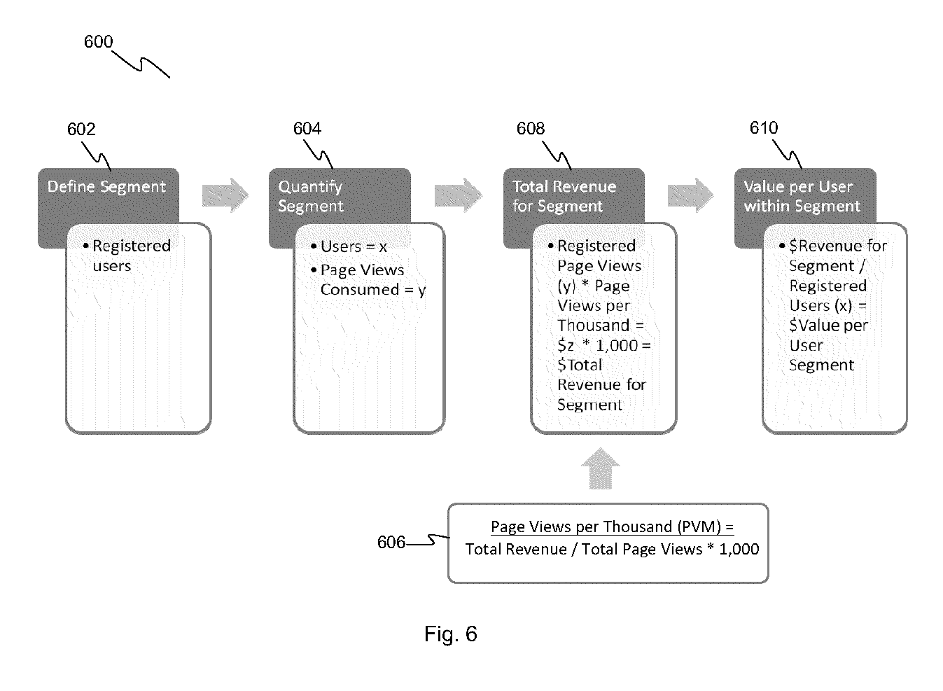

FIG. 6 is a flow chart 600 of an embodiment method for website user valuation. Generally, the method observes the average volume of page views per user segment, and multiplies that quantity by the average value of a page view per banner and sponsorship revenue of a website. The results may be compared to determine the relative value of different user segments to the website provider. In one embodiment the calculations may be implemented in a computer spreadsheet program receiving as input categorical information about the user segments and site revenue data. The spreadsheet then calculates the specific amount of revenue attributable to each user based on user segment. The algorithms alternatively may be implemented in a different type of computer program, such as a document editor, a relational database program, a dedicated computer program written in a programming language such as C++, Visual Basic, HTML, XML, and the like.

In step 602, different user segments are defined based on user characteristics that are of interest to the website provider. In this example, the registered user segment is shown, but the users also may be grouped as non-registered users, local or non-local users, CGM viewers, engaged CGM participants, specials subscribers, referred users or non-referred users, classified page users or non-classified page users, and the like.

As users access the website and the website server provides web pages to the users, the website analytic tool may store quantitative information about the users' engagement actions with the website in step 604. In this example, the monitored actions are page views, although other metrics may be monitored, such as unique visitors, new registrations, email subscriber opt-in, and the like. The website analytic tool stores the number users for each user segment and the number of page views for each type of user segment being monitored. Here, the number of registered users is stored, along with the number of page views by those registered users. The monitoring may be performed for a certain period of time, such as a day, week, month, year-to-date, or year, or any combination or multiple thereof. Likewise, the data may be stored for each user segment for similar time periods. Alternatively, the website analytic tool may store raw data to be grouped into selected time periods and selected user segments in subsequent analysis. Examples of these measurements are provided in FIG. 7a, described in detail below.

Once sufficient data about user engagement activity has been collected for analysis, the website user valuation tool may determine the average page view per thousand rate (“PVM”) in step 606. The average PVM is website revenue times user page views divided by 1000, for each of the selected time periods. Using this rate, the user valuation tool may analyze each user segment in step 608 to determine revenue per user segment. The user valuation tool takes as inputs the user engagement data and overall revenue data for the website over the same time periods. The revenue data may be based on banner and sponsorship revenue for the website. Other forms of revenue may be included as discussed herein below. The total revenue for the registered user segment is determined as (registered user page views*PVM*1000). Examples of these calculations are described in detail below with reference to FIGS. 7b and 7c.

The website user valuation tool also may determine the value per user for each user segment in step 610. These values are determined as shown in FIG. 7c and accompanying text. For the registered user segment, value per user is calculated as (revenue user segment revenue/number of registered users). The value per user for each user segment provides a ready comparison of the relative values of each user segment to the website provider. The website provider may utilize these numbers in determining strategy and tactics for further improving the website, attracting new users, increasing the value of existing users, and the like, as discussed in the previous embodiment.

FIG. 7a is a table 700 illustrating data acquisition for website user valuation. Table 700 lists revenue and engagement data that may be measured by the website analytic tool as users interact with one or more websites. In the examples of FIGS. 7a-7c, data is collected for a first website 702 and also for a website group 704 comprising multiple websites. The time periods illustrated for the data are monthly 706 and year-to-date 708. Alternatively or in addition, revenue and user engagement data may be analyzed for other time periods, such as daily, weekly, yearly, and the like. It should be noted that the specific data provided in the tables and used for comparisons between segments is for example only and does not represent actual measurements or calculations. The specific values are provided to facilitate understanding of embodiments of the present invention.

In the data acquisition table 700, revenue data 710 represents the total amount of revenue generated by the website. Different revenue models may be used. For example, the revenue model may be a page view model, wherein the revenue is allocated to web pages consumed by different user segments. Additionally or alternatively, the revenue model may be a cost per acquisition model, wherein the revenue from leads is allocated to leads generated by different user segments. Additionally or alternatively, the revenue model may be a subscriber model, wherein the subscriber revenue is allocated to different subscriber segments. Examples of revenue sources for these revenue models include display advertising, banner, sponsorship, classified listings, lead revenue, My Specials Direct (“MSD”) (email advertisements sent to specials subscribers) revenue, newsletters, alerts, or various other methods of generating profit on a website. Data sources may include internal company data or revenue reports generated by third parties.

The remaining entries in data acquisition table 700 may be measured by the website analytic tool when monitoring user engagement activity of the website provided by the web server. User engagement activity may include page views 712, unique visitors 714, registrations 716, and MSDs 718. With respect to page views 712, user page views are measured within a certain time period, for example a calendar month or year-to-date, but could be modified to be any time period. The first entry under page views 712 is total page views 712a, which simply is a measure of all pages viewed by all website visitors in the respective time period, regardless of user segment. Page views may be measured in different ways. For example, all pages viewed by a user may be counted, even if repeated, or a page may only be counted once per visit for a specific user of the website, regardless of how many times the user returns to that page.

Further categories under page views 712 represent page views for different user segments that the users have been grouped into, such as registered users, non-registered users, CGM viewers, and engaged CGM participants. Registered page views 712b represents page views by all users that are in the registered visitor user segment within a calendar month (as well as year-to-date). Non-registered page views 712c represents page views by all users that are in the non-registered visitor user segment within a calendar month. CGM viewer page views 712d represents page views by all users that are in the CGM viewer user segment within a calendar month. These users are visitors who have viewed user generated content on a site, but did not provide user generated content to the site during the visit. Engaged CGM participant page views 712e represents page views by all users that are in the engaged CGM participant user segment within a calendar month. These users are visitors who have provided user generated content to the site.

The next category of engagement is unique visitors 714. This is the amount of unique visitors to the website identified within a specific time period, such as a calendar month. Total unique visitors 714a represents the total number of unique visitors who visited the site within the course of the month (and year-to-date), regardless of user segment. Unique CGM viewer 714b represents the total number of unique visitors who viewed a page that contained user generated content. In this example, this number excludes the initial page view that contains user generated content. Alternatively, the initial page view may be included. Unique engaged CGM participant 714c represents the number of unique visitors who added content to the website.

The registrations category 716 monitors the number of visitors who have registered with the site. More information may be known about these visitors because in registering the visitors may have disclosed certain information, such as email address, age, gender, and income. Total registered users 716b represents the total number of registered visitors for the current month (and year-to-date), regardless of user segment. New registrations 716b represents the number of new user registrations for the current month. Newly engaged CGM participant 716c represents the number of new user registrations that were undertaken because a visitor wanted to add content to the site. These new registrations, therefore, are attributed to CGM.

The last category in the table is MSDs (email subscribers) 718, which includes visitors who have elected to receive emails from the web site. Total MSD subscribers 718a represents the total number of email subscribers for the month (and year-to-date), regardless of user segment. MSD opt-ins 718b represents the number of new MSD opt-ins for the current month. MSD opt-ins % 718c represents the percentage of MSD opt-ins for the current month, and is based on the current month's number of new registrations.

FIG. 7b is a table 720 illustrating intermediate revenue determination for various types of website users. The user valuation tool may derive this data based on the revenue and user engagement information described above in table 700 of FIG. 7a. This data may then be used by the user valuation tool to generate the per user and user segment valuations shown in FIG. 7c.

In FIG. 7b, the page view rate category 722 represents a rate value that is used to calculate the amounts of various revenues. In this category is average pages viewed per thousand (“PVM”) rate 722a, which represents an average page view per thousand rate. The average PVM rate may be determined by the formula: (Banners and Sponsorships Revenue/Total Page Views)*1000. The average PVM rate represents the revenue from banners and sponsorships divided by total page views and multiplied by 1,000. Again, this rate value is used to calculate the amounts of various revenues, as will be shown below.

Various calculations are then made to determine different forms of user revenue 724. The newly engaged registered user revenue 724a is determined by (Newly Engaged CGM Participant*(Total Engaged CGM Participant Page Views/Total Engaged CGM Participant Unique Visitors)*Total Average PVM Rate). This calculation provides the amount of revenue generated for every thousand pages viewed by a newly engaged participant. Because this type of user has engaged with the site, this means that they have completed the registration process and are also registered users.

The PVM viewer revenue 724b is calculated as (CGM Viewer Page Views*Average PVM Rate). This calculation provides the amount of revenue generated, for every thousand pages viewed on a site.

User value revenue 724c is determined from (Total Page Views*Average PVM Rate). This value provides the total user value revenue based on the number page views and the Average PVM Rate. This number generally will be equal to the revenue generated from the site, which is located under Banner/Sponsorship in website revenue 710 in FIG. 7a.

The next series of values calculated represent different types of engaged user incremental value 726. PVM engaged user revenue 726a is determined as (Engaged CGM Participant Page Views*Average PVM Rate). This calculation provides the amount of revenue generated for every thousand pages viewed by those visitors who added content to the site.

Engaged user MSD conversion revenue 726b is calculated by (Newly Engaged CGM Participant*(New Registrations/MSD Opt-ins)*MSD Value Per User). This calculation provides the amount of total revenue generated for every thousand pages viewed by those newly registered visitors, who opted in to receive an MSD email, who added content to the site.

Total CGM engaged revenue 726c represents (PVM Engaged User Revenue+Engaged User MSD Conversion Revenue). This calculation provides the combined incremental revenue of engagement from engaged users and MSD (email) subscribers.

Total CGM revenue 728 is determined as (PVM Viewer Revenue+Total CGM Engaged Revenue). This calculation adds together PVM viewer revenue and total CGM engaged revenue.

FIG. 7c is a table 730 illustrating valuations for various types of website users and user segments. This information is grouped as segmented values per user 732 and segmented revenues by user category 734. These results are calculated from the data acquired in table 700 in FIG. 7a and the data calculated in table 720 in FIG. 7b.

Total values per user 732 are determined for different user segments, such as CGM viewers, engaged CGM participants, registered users, non-registered users, and MSD users. Total user value 732a is determined as (User Value Revenue/(Total Unique Visitors*1000)). This calculation provides the amount that each unique visitor of the site was worth for the month.

CGM value per user 732b is calculated as (Total CGM Revenue/(Unique Engaged CGM Participant+Unique CGM Viewers*1000)). This value provides the CGM value for a given month per user.

CGM viewer value per user 732c is calculated as (CGM Viewer Revenue/(Unique CGM Viewers*1000)). This calculation provides the CGM viewer value for a given month per user.

CGM engaged user value per user 732d is determined by (Total CGM Engaged Value/(Engaged CGM Participant*1000)). This value provides the CGM engaged user value per user.

Registration user value per user 732e is represented by ((Registered Page Views/Total Registered Users)*Average PVM/1000). This value provides the registration user value per user.

Non-registered user value per user 732f is calculated by ((Registered Page Views/Total Registered Users)*Average PVM/1000). This calculation provides the non-registered user value per user.

MSD value per user 732g is determined by (Total MSD Subscribers for the Month/MSD Revenue by Month). This calculation provides the MSD value per user.

Segmented revenue by user category 734 also may be determined by the user valuation tool, as shown in the following calculations.

Total user revenue 734a is calculated as ((Total Unique Visitors*1000)*Total User Value). This calculation provides the total amount of revenue generated for a site. This value will be the same as the Banner/Sponsorship amount listed under revenue 710 in FIG. 7a.

Registered user revenue 734b is determined from ((Total Registered Users*1000)*Registered User Value per User). This value provides the amount in dollars of attributable revenue from the registered user segment.

Non-registered user revenue 734c is determined from ((Total Non-Registered Users*1000)*Non-Registered User Value per User). This calculation provides the amount in dollars of attributable revenue from the non-registered user segment.

CGM viewer user revenue 734d is calculated by ((CGM Viewer Value per User*1000)*CGM Viewer). This calculation provides the amount in dollars of attributable revenue from the CGM viewer user segment.

Engaged CGM participant user revenue 734e is determined by ((Total Engaged CGM Participant*1000)*CGM Engaged Revenue). This value provides the amount in dollars of attributable revenue from the engaged CGM participant user segment.

Newly engaged CGM participant user revenue 734f is represented by ((New Content Contributor*1000)*CGM Engaged Value per User). This calculation provides the amount in dollars of attributable revenue from the newly engaged CGM participant user segment.

Total CGM value 734g is calculated as (CGM Viewer User Revenue+Engaged CGM Participant User Revenue). This value provides the revenue value of all CGM activity on a site.

As previously discussed, the above analyses provide a wealth of information useful to a website provider in determining the relative values of different user segments based on their engagement levels with the website. Many different comparisons between user segments may be made to compare their relative values to the website provider. Fictitious examples of different types of comparisons are given below to illustrate the usefulness of the results provided by the user valuation tool.

As an example, although only 5% of visitors may be registered, 35% of banner and sponsor revenue may be attributed to these registered visitors. Engaged CGM participants may consume over twice as many pages in a visit than an average visitor. Registered visitors may consume ten times more pages than a non-registered visitor. Local visitors may consume twice as many page views as non-local visitors, and may generate over 30, 40 or 50% of all revenue. Local registered visitors may consume 5-10 times as many page views as their local non-registered counterparts. Local non-registered visitors may consume more than twice as many page views as non-local non-registered visitors. A local CGM viewer may average 5-10 more page views than a non local CGM viewer. A local engaged CGM participant may average 10-20 more page views than a non-local CGM participant. The relative values of the various user segments are readily apparent from these and other comparisons of the user segments.

As another example, non-registered visitors may visit 5 pages a month on a website, while registered visitors may visit 50 pages a month. Therefore a registered user is more highly valued because of the increased number of advertising impressions they consume per the pages viewed per thousand (PVM) rate.

As another example, local visitors may make up a small percentage, such as 15-20%, of total visitors to a website. Local visitors, however, may consume two, three, four or more times as many page views as non-local visitors, and may generate a much higher percentage of total revenue (e.g., two times or more) than their percentage of the total visitors. Based on this information, for example, a website provider may give priority to local visitors, or may implement website modifications to increase the value of non-local visitors, or both.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A computer system comprising:
a memory storing a computer program;
a data processor for executing the computer program stored in the memory; and
the computer program stored in the memory, the computer program comprising computer code for website user valuation, the computer code including
instructions for inputting revenue data for a period of time for a monitored website,
instructions for inputting website user engagement data for the period of time for multiple user segments,
instructions for determining a segment revenue for the period of time for each of the multiple user segments, based on the user engagement data, and
instructions for determining a value per user for the period of time for each of the multiple user segments, based on the user engagement data.

2. The computer system of claim 1, wherein the revenue data is banner and sponsorship revenue data.

3. The computer system of claim 1, wherein the time period is one month.

4. The computer system of claim 1, wherein the multiple user segments comprise categories selected from the group consisting of: registered users, non-registered users, local users, non-local users, consumer generated media (CGM) viewers, engaged CGM participants, and combinations thereof.

5. The computer system of claim 1, wherein user engagement data comprises web page views for the period of time for each of the multiple user segments.

6. The computer system of claim 5, wherein the computer code further comprises instructions for calculating a page views per thousand (PVM) rate determined from the revenue data divided by a total of the web page views for all of the user segments times 1000.

7. The computer system of claim 1, wherein the user engagement data is selected from the group consisting of: unique visitors, new registrations, email subscriber opt-in, and combinations thereof.

8. A computer program product for performing website user valuation, the computer-program product having a computer-readable medium with a computer program embodied thereon, the computer program comprising:
computer program code for inputting revenue data for a period of time for a monitored website;
computer program code for inputting website user engagement data for the period of time for multiple user segments;
computer program code for determining a segment revenue for the period of time for each of the multiple user segments, based on the user engagement data; and
computer program code for determining a value per user for the period of time for each of the multiple user segments, based on the user engagement data.

9. The computer program product of claim 8, wherein the revenue data is banner and sponsorship revenue data.

10. The computer program product of claim 8, wherein the time period is one month.

11. The computer program product of claim 8, wherein the multiple user segments comprise categories selected from the group consisting of: registered users, non-registered users, local users, non-local users, consumer generated media (CGM) viewers, engaged CGM participants, and combinations thereof.

12. The computer program product of claim 8, wherein user engagement data comprises web page views for the period of time for each of the multiple user segments.

13. The computer program product of claim 12, further comprising computer program code for calculating a page views per thousand (PVM) rate determined from the revenue data divided by a total of the web page views for all of the user segments times 1000.

14. The computer program product of claim 8, wherein the user engagement data is selected from the group consisting of: unique visitors, new registrations, email subscriber opt-in, and combinations thereof.

15. A method for website user valuation, the method comprising:
inputting revenue data for a period of time for a monitored website;
inputting website user engagement data for the period of time for multiple user segments;
determining, using a microprocessor, a segment revenue for the period of time for each of the multiple user segments, based on the user engagement data; and
determining, using a microprocessor, a value per user for the period of time for each of the multiple user segments, based on the user engagement data.

16. The method of claim 15, wherein the revenue data is banner and sponsorship revenue data.

17. The method of claim 15, wherein the time period is one month.

18. The method of claim 15, wherein the multiple user segments comprise categories selected from the group consisting of: registered users, non-registered users, local users, non-local users, consumer generated media (CGM) viewers, engaged CGM participants, and combinations thereof.

19. The method of claim 15, wherein user engagement data comprises web page views for the period of time for each of the multiple user segments.

20. The method of claim 19, further comprising calculating, using a microprocessor, a page views per thousand (PVM) rate determined from the revenue data divided by a total of the web page views for all of the user segments times 1000.

21. The method of claim 15, wherein the user engagement data is selected from the group consisting of: unique visitors, new registrations, email subscriber opt-in, and combinations thereof.
